(19) United States
(12) Patent Application Publication
(10) Pub. No.: US 2021/0057726 A1
(43) Pub. Date: Feb. 25, 2021

(54) METHODS AND COMPOSITIONS FOR SOLID ELECTROLYTE INFILTRATION INTO ACTIVE MATERIAL

(71) Applicant: Blue Current, Inc., Hayward, CA (US)

(72) Inventors: Richard Hoft, Palo Alto, CA (US); Eduard Nasybulin, Fremont, CA (US); Kevin Wujcik, Berkeley, CA (US)

(21) Appl. No.: 16/947,887

(22) Filed: Aug. 21, 2020

Related U.S. Application Data
(60) Provisional application No. 62/891,159, filed on Aug. 23, 2019.

(51) Int. Cl. H01M 4/36; H01M 4/131; H01M 4/133; H01M 4/134; H01M 4/38; H01M 4/525; H01M 4/88; H01M 4/505; H01M 4/04; H01M 10/0525

(52) U.S. Cl. CPC H01M 4/364; H01M 4/366; H01M 4/131; H01M 4/133; H01M 4/134; H01M 4/386; H01M 2300/0068; H01M 4/8828; H01M 4/505; H01M 4/0471; H01M 4/0416; H01M 10/0525; H01M 4/525

(57) ABSTRACT

Provided herein are methods and compositions of coating active material with solid electrolyte or solid electrolyte precursors. Active material may be used in cells of a battery, e.g., electrodes, that allow for ion transport across an electrolyte. Coating active material with solid electrolyte may improve ionic transport through the electrode.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### BACKGROUND

Lithium ion batteries may use solid or liquid electrolytes. Liquid electrolytes can easily make contact with the surface and percolate into the pores of active material particles, establishing strong ionic contacts throughout the electrode. However, liquid electrolytes are flammable and unstable. If a battery short circuits, electrons flow uncontrollably from the anode to the cathode where they meet with lithium ions and spontaneously release the cells' electrochemical energy, causing catastrophic failure events such as fire or explosion.

To reduce catastrophic failures, flammable liquid electrolytes may be replaced with nonflammable, solid electrolytes. Solid-state electrolytes may be less flammable than conventional liquid organic electrolytes. Solid-state electrolytes, however, cannot easily make contact with active material particles, leading to reduced performance.

### SUMMARY

Disclosed herein are methods and compositions for improving solid electrolyte infiltration into active material particles.

In one aspect of the embodiments herein, a method is provided, the method including: dissolving an electrolyte precursor in a solvent to form a solution; adding active material to the solution; precipitating the electrolyte precursor out of the solution to form a composite powder; and mixing the composite powder with a slurry solvent. In some implementations, the method further includes: mixing the composite powder with an electrolyte reactant, and reacting the electrolyte precursor of the composite powder with the electrolyte reactant in the presence of the solvent to form an electrolyte coating on the active material. In some implementations, the method further includes mixing the composite powder with one or more additives. In some implementations, the one or more additives are one or more of carbon, carbon fiber, graphene, or organic phase additives. In some implementations, the weight percent of electrolyte precursor in the solution is at most about 3.0 wt %. In some implementations, the method further includes drying the composite powder prior to mixing the composite powder with a solvent. In some implementations, the slurry solvent is THF. In some implementations, the method further includes mixing the composite powder with carbon. In some implementations, the method further includes degassing the solution containing solvent, electrolyte precursor, and active material.

In another aspect of the embodiments herein, a composition is provided, including a dry mixture of: particles of an active material for a lithium ion battery electrode, the particles at least partially coated with a layer of Li₂S; and P₂S₅. In some implementations, the active material is NMC, and an average mass percent of sulfur on the active material, as calculated by the equation

$$\frac{mass of Sulfur}{mass of Sulfur + mass of Nickel} \times 100 \%$$

is at least 40%. In some implementations, the active material is NMC and the particles are homogenously coated as characterized by a standard distribution of mass percent of sulfur of no more than 10% across the particles, wherein mass percent of sulfur on the active material is calculated by the equation

$$\frac{mass of Sulfur}{mass of Sulfur + mass of Nickel} \times 100 \% .$$

In some implementations, the active material is a cathode active material. In some implementations, the cathode active material is one or more of the group consisting of: NMC, lithium cobalt oxide (LCO), lithium manganese oxide (LMO), lithium nickel cobalt aluminum oxide (NCA), and lithium iron phosphate (LFP). In some implementations, the active material is an anode active material. In some implementations, the anode active material is one or more of the group consisting of: carbon-containing active materials and silicon-containing active materials.

In some implementations, the composition does not include additives. In some implementations, the composition further includes an electronic conductivity additive. In some implementations, the composition of claim 10, further includes an organic phase additive. In some implementations, a molar ratio between Li₂S and P₂S₅ is between about 3:1 and about 1:1. In some implementations, a battery cell using an electrode made from the composition of claim 1 has a C/10 capacity that is at least 77% of its C/20 capacity.

In another aspect of the embodiments herein, a composition is provided, including: a slurry precursor solution including: particles of an active material for a lithium ion battery electrode, the particles at least partially coated with a layer of Li₂S; P₂S₅; and slurry solvent. In some implementations, the active material is NMC, and an average mass percent of sulfur on the active material, as calculated by the equation

$$\frac{mass of Sulfur}{mass of Sulfur + mass of Nickel} \times 100 \%$$

is at least 40%. In some implementations, the active material is NMC and the particles are homogenously coated as characterized by a standard distribution of mass percent of sulfur of no more than 10% across the particles, wherein mass percent of sulfur on the active material is calculated by the equation

$$\frac{mass of Sulfur}{mass of Sulfur + mass of Nickel} \times 100 \% .$$

In some implementations, the active material is a cathode active material. In some implementations, the cathode active material is one or more of the group consisting of: NMC, lithium cobalt oxide (LCO), lithium manganese oxide (LMO), lithium nickel cobalt aluminum oxide (NCA), lithium iron phosphate (LFP). In some implementations, the active material is an anode active material. In some implementations, the anode active material is one or more of the group consisting of: carbon-containing active materials and silicon-containing active materials. In some implementations, the composition does not include additives. In some implementations, the composition further includes an electronic conductivity additive. In some implementations, the composition further includes an organic phase additive. In some implementations, a molar ratio between Li₂S and P₂S₅ is between about 3:1 and about 1:1. In some implementations, a battery cell using an electrode made from the composition of claim 1 has a C/10 capacity that is at least 77% of its C/20 capacity.

In another aspect of the embodiments herein, a method is provided, the method including: dissolving a solid electrolyte into a solvent to form a solution; adding active material to the solution; precipitating solid electrolyte out of the solution to form coated active material; annealing the coated active material at a temperature between 350-500° C.; and mixing the coated active material with a slurry solvent to form a slurry. In some implementations, the method further includes drying the coated active material prior to annealing. In some implementations, drying the coated active material comprises heating the coated active material to a temperature of at least 100° C. for at least 12 hours. In some implementations, the method further includes casting the slurry to form an anode of a battery cell.

In some implementations, the active material is an anode active material. In some implementations, the anode active material is one or more of the group consisting of: graphite, silicon, silicon-containing compositions, and silicon alloys. In some implementations, the method further includes mixing the coated active material with one or more additives. In some implementations, the method further includes mixing the coated active material with one or more carbon. In some implementations, the method further includes degassing the solution containing alcohol, solid electrolyte, and active material.

These and other features of the disclosed embodiments will be described in detail below with reference to the associated drawings.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 presents a flow diagram of an operation for one example embodiment.

FIG. 2 presents a flow diagram of an operation for one example embodiment.

FIG. 3 presents SEM images of films according to embodiments described herein.

FIGS. 4A and 4B present graphs of electrical performance of films made according to embodiments described herein.

### DETAILED DESCRIPTION

Particular embodiments of the subject matter described herein may have the following advantages. In some embodiments, compositions or slurries having improved contact between a solid electrolyte and active materials are provided. The compositions or slurries, if incorporated into a battery, may exhibit better charge capacity retention across loading cycles than batteries that do not incorporate the compositions or slurries. In some embodiments, the ionically conductive solid-state compositions may be processed to a variety of shapes with easily scaled-up manufacturing techniques. The compositions may be slurries that can be cast into a variety of shapes.

The compositions described herein include coated active material. An “active material” is defined as an electrode's component that provides ion insertion sites. Each electrode in an electrochemical cell has at least one corresponding active material. “Coated active material” as used herein refers to a material including an active material, which may be used as the cathode or anode in a battery, at least partially coated with solid electrolyte or solid electrolyte precursor. Coating active material particles with solid electrolyte improves ionic transport throughout the electrode by increasing the contact area between ion conducting components (solid electrolyte) and the active material.

Example cathode active materials include lithium cobalt oxide (LCO), lithium manganese oxide (LMO), lithium nickel cobalt aluminum oxide (NCA), lithium iron phosphate (LFP), and lithium nickel manganese cobalt oxide (NMC). Example anode active materials include graphite and other carbon-containing materials, silicon and silicon-containing materials, tin and tin-containing materials, lithium and lithium alloyed metals.

As described further below, active material particles may be coated with solid electrolyte and/or precursors thereof according to various embodiments. Solid electrolyte precursors are compounds that can be reacted to form a solid electrolyte. Examples of such solid electrolytes and their precursors include:

| | Solid Electrolyte | | Precursor |
|---|---|---|---|
| Solid Electrolyte | Solvents | Electrolyte Precursor | Solvents |
| Li₃PS₄ (LPS) | | Li₂S, P₂S₅ | Ethanol |
| Li₆PS₅Cl argyrodite | Ethanol | LiCl, Li₂S, and P₂S₅ | Ethanol |
| Li₆₋ₓPS₅₋ₓHal₁₊ₓ argyrodite | Ethanol | LiHal, Li₂S, and P₂S₅ | Ethanol |
| where Hal is Cl, Br, or I | | | |
| 0.4LiHal—0.6Li₄SnS₄ | Methanol | Li₄SnS₄, LiI | Methanol |
| Li₄SnS₄ | Methanol, | Li₂S, Sn, S | Methanol, |
| | Deionized water | | Deionized water |

As indicated above, the solid electrolytes may be argyrodite solid electrolytes in some embodiments. In some embodiments, the solid electrolyte is a Li₃PS₄ based solid electrolyte or a Li₄SnS₄ based solid electrolyte. In some embodiments, the solid electrolytes or electrolyte precursors are soluble in a solvent that does not react, or has a negligible rate of reaction, with either the dissolved electrolyte or electrolyte precursor, or the active material to be coated. In some embodiments the solid electrolyte is not soluble in the same solvents as its precursors, or to the same wt % as its precursors.

Higher contact area between an active material and electrolyte in an electrode increases ionic conductivity between the electrolyte and the active material. Solid electrolyte, however, cannot make contact with active material as easily as liquid electrolyte.

Provided herein are methods of providing high contact area between the solid electrolyte and an active material. In some embodiments, the methods include dissolving solid electrolyte (or electrolyte precursor) to form a solution, stirring active material into the solution to wet the surface of active material particles, and precipitating the solid electrolyte (or electrolyte precursor) out of solution to coat the active material. The coated active material may then be used as part of a mixture or slurry for casting as an electrode. This process may be advantageous as it reduces the particle size of the solid electrolyte, coats the solid electrolyte onto the surface of active material particles, and deposits solid electrolyte into the pores of active material particles, all of which increases the contact area between the solid electrolyte and the active material.

In some embodiments, electrolyte precursor is coated onto active materials. In such embodiments, a later process may be performed to react the electrolyte precursor to form solid electrolyte. It should be generally understood that techniques disclosed herein for coating active material particles with solid electrolyte may be equally applicable to coating active material particles with electrolyte precursor and vice-versa, subject to a later reaction to modify the electrolyte precursor to form a solid electrolyte.

The methods allow coating of active materials of very small particles and are easy to scale. Other solutions to improve the contact area between solid electrolyte and active material include ball-milling or applying high pressure (>300 MPa) to the electrode layer. Ball-milling may be used to reduce particle size to the order of a few microns, but may be insufficient as a technique for smaller particle sizes. Densifying electrode layers using high pressure can be expensive and difficult to scale. In some embodiments these methods may be used in addition to, or as part of, operations described herein regarding coated active material.

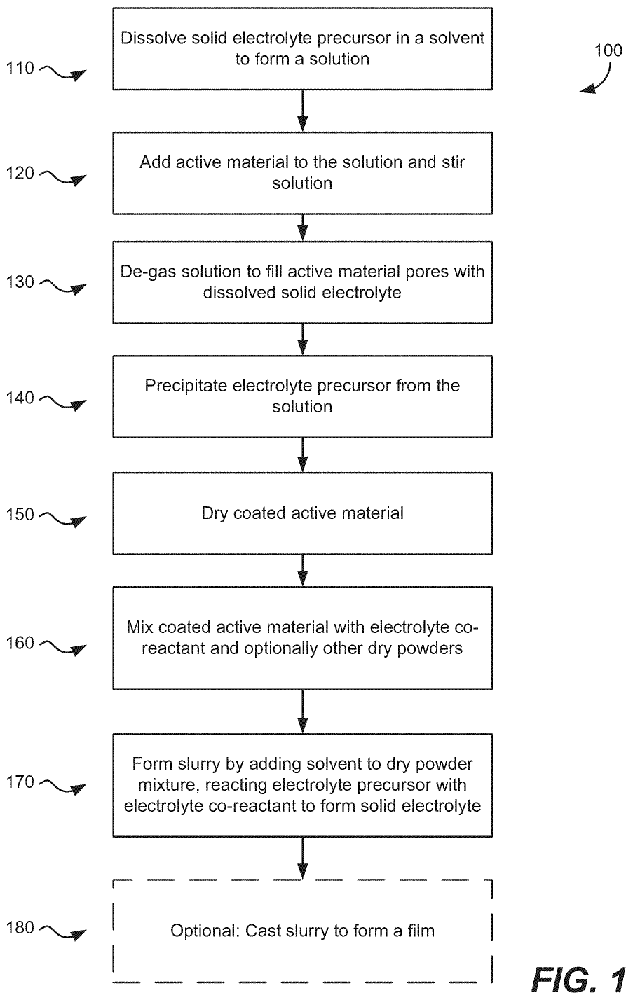

FIG. 1 depicts a process flow 100 for forming a slurry containing coated active material. In operation 110 electrolyte precursor is dissolved into a solvent to form a solution. In some embodiments, the solvent is ethanol. In some embodiments, the electrolyte precursor is Li₂S. Li₂S may dissolve in ethanol up to about 3.0 wt %, at which point the ethanol may be saturated with electrolyte precursor. The description below refers to ethanol however, other solvents and electrolytes/electrolyte precursors may be used, depending on the solubility of the electrolyte/electrolyte precursor in the solvent.

In operation 120 active material particles are added to the solution and the solution is stirred. Stirring mixes the active material particles and the electrolyte precursor containing solution together, coating the active material particles with electrolyte precursor. In some embodiments the solution is stirred for about thirty minutes, or between thirty minutes and an hour. In some embodiments the solvent may react undesirably with the electrolyte precursor and/or the active material. The mixing time to ensure sufficient wetting of the active material may be balanced against undesirable reactions with the solvent. In some embodiments active material is insoluble, or has negligible solubility, in the ethanol/electrolyte precursor solution. In some embodiments the active material is a cathode active material, such as NMC.

In some embodiments, the ratio of active material particles to dissolved electrolyte precursor is determined based on a desired wt % of solid electrolyte in a cast electrode film. As discussed further below, an anode or cathode composition may have a wt % of solid electrolyte of between about 10%-33% or between about 10%-50%, and a wt % of active material between about 65%-88% or between about 20%-90%. The amount of active material added to the solution may be adjusted to achieve these respective wt % in the final film based on the assumption that all of the solid electrolyte in the final composition is from, or formed from a reaction with, the electrolyte precursor solution described in operation 110. In other embodiments, more active material is added than may be the respective wt % in the final film, and additional electrolyte or electrolyte precursor is added after coating the active material as described in operations 160 and 170 below.

In operation 130 the solution is de-gassed. In some embodiments de-gassing is performed at below ambient pressure, less than about 700 torr, or at about 600 torr. In some embodiments de-gassing is performed at a low temperature, such as 60° C., or at a temperature between about 25° C. and 78° C. De-gassing may be advantageous to fill pores of the active material with electrolyte precursor. In some embodiments de-gassing may be performed under temperature and pressure where the solvent will undergo nucleate boiling, for example below about 80° C. at about atmospheric pressure for ethanol. This may be advantageous to avoid reducing the wetting of the surface of active material particles due to turbulence from the vaporizing solvent. Generally, better wetting leads to a better coating on the surface of active material particles, which increases contact area between the active material and the electrolyte.

Additionally, in some embodiments the ethanol may react with the electrolyte precursor and/or the active material. Removing the ethanol at a lower temperature may reduce the rate of reaction, reducing the formation of undesirable reaction products.

In operation 140 electrolyte precursor is precipitated out of the solution. The electrolyte precursor may precipitate into the pores of and onto the active material, at least partially coating the active material. Precipitation may be performed at a lower pressure than de-gassing, such as about 10 torr, or less than about 10 torr, and at a low temperature, such as between about 50° C. and 70° C. In some embodiments, the lower pressure is advantageous to reduce the particle size of precipitated electrolyte precursor, compared to precipitation at a higher pressure.

In some embodiments operations 130 and 140 may be performed together, such that some electrolyte precursor may precipitate out of solution during operation 130. In some embodiments it is preferable to minimize precipitation during operation 130 to maximize the surface area of active material particles that may act as a nucleation site for precipitating electrolyte precursor during operation 140. The result of operation 140 is a composite material of active material coated with electrolyte precursor. In some embodiments, the electrolyte precursor/active material composite has a mass ratio of about 10% electrolyte precursor:about 90% active material, for example 10% Li₂S: 90% NMC.

In operation 150 the coated active material is dried. Drying may be performed at a higher temperature than de-gassing or precipitation, such as at least about 100° C. or about 140° C., as well as at reduced pressure, such as about 10 torr, or less than about 10 torr. In some embodiments drying is performed for at least about 15 hours, or at least about 10 hours. Higher temperatures may be used for drying than for de-gassing or precipitation to further remove any solvent contamination or carbonation. Remaining solvent or gas pockets may negatively affect the electrical conductivity or performance of the coated active material. Thus, drying may be advantageous to remove any undesirable contaminants in the coated active material. Additionally, in some embodiments the remaining solvent is insufficient to negatively affect the coated active material if heated much higher than its boiling temperature, compared to de-gassing or precipitation in operations 130 and 140, respectively.

In operation 160 the dried, coated active material is mixed with other dry powders to form a dry mixture. Notably, if the coated active material includes an electrolyte precursor, the other dry powders may include an electrolyte co-reactant, such as a composition of Li₂S and P₂S₅. In some embodiments the Li₂S and P₂S₅ composition may have a molar ratio of Li₂S:P₂S₅ of about 3:1. Other ratios may be used, including ratios between about 3:1 and 1:1. In some embodiments, the other dry powders mixed with coated active material in operation 160 are only electrolyte co-reactant. In some embodiments the electrolyte co-reactant will not react with the electrolyte precursor while in a dry powder form. Other dry powders may include additives, which may be added to improve the manufacturability of a film made using the slurry described herein, the electrical properties of the film, the mechanical properties of the film, or the porosity of the film. For example, carbon black may be mixed with the coated active material particles to improve conductivity.

In operation 170 the dry mixture of coated active material with other dry powders is combined with a solvent, and optionally additional additives or organic phases, to form a slurry. In some embodiments the solvent is THF. The solvent may facilitate a reaction between the electrolyte precursor and the electrolyte co-reactant to form solid electrolyte on the active material. In some embodiments a electrolyte co-reactant, such as Li₂S and P₂S₅, react with Li₂S that is coated onto the active material particles, forming Li₃PS₄ (LPS). The combination of the dry mixture, solvent, and other additives or organic phases may be accomplished by a roller mixer. Other mixing methods may be used as generally understood in the field.

Additives may be added to improve various properties, similar to the dry powders described in operation 160. Example additives may be hydrogenated hydroxyl-terminated polyolefin (HLBH) or nitrile butadiene rubber (NBR). In some embodiments the additives are unavailable in a powder form. In some embodiments the dry powders described in operation 160 may be added in operation 170 instead, or in addition to operation 160.

Finally, operation 180 is an optional operation to cast the slurry formed in operation 170 to create a film. The film may be cast in a variety of ways. In some embodiments a film is cast by coating the slurry on aluminum foil such that the area mass loading is about 3 mAh/cm². In some embodiments the film is dried at an elevated temperature and reduced pressure. For example, the film may then be dried at a temperature of at least about 120° C. and at a reduced pressure of about 10 torr or no more than about 10 torr for at least about one hour.

In some embodiments, operations 160 and 170 are not performed. After drying the coated active material, the coated active material may be stored or transferred. The coated active material may then be mixed with electrolyte co-reactant and reacted to form a solid electrolyte at a later operation. In some embodiments, operation 170 is not performed. In such embodiments, the coated active material, electrolyte co-reactant, and other dry powder additives are mixed, and the dry mixture may be stored or transferred for later use. In some embodiments, operation 160 is not performed, and the coated active material is directly added to a solvent to form a slurry without mixing with other dry powders, such as in operation 170. In such embodiments, other dry powders may also be directly added to the solvent as part of operation 170, rather than a separate mixing step as described in operation 160 above.

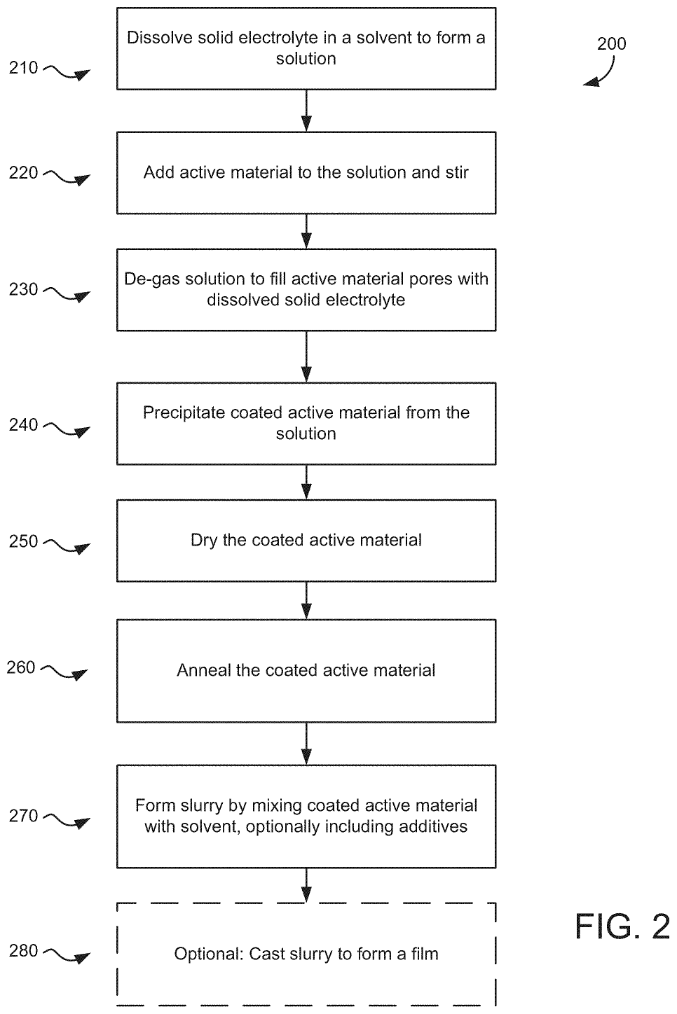

FIG. 2 presents an alternative process 200 for forming a slurry containing coated active material. Process 200 may be used to coat an anode active material with solid electrolyte, such as an argyrodite solid electrolyte. In operation 210 solid electrolyte is dissolved into a solvent to form a solution. In some embodiments, the solvent is ethanol. In some embodiments, the solid electrolyte is an argyrodite solid electrolyte. Argyrodite solid electrolyte may dissolve in ethanol up to between about 7.0 and 10.0 wt %, at which point the ethanol may be saturated with electrolyte. In some embodiments, a solid electrolyte having a high halide content may be used for its improved conductivity.

In operation 220 active material particles are added to the solution and the solution is stirred. Stirring mixes the active material particles and the dissolved solid electrolyte, coating the active material particles with solid electrolyte. In some embodiments the solution is stirred for at about thirty minutes, or between thirty minutes and an hour. In some embodiments the solvent may react undesirably with the electrolyte and/or the active material. The mixing time to ensure sufficient wetting of the active material may be balanced against undesirable reactions with the solvent. In some embodiments active material is insoluble in the ethanol/solid electrolyte solution. In some embodiments the active material is an anode active material, such as graphite. In some embodiments, other compounds may be added to the solution to improve the contact area between solid electrolyte and the other compounds similar to improving the contact area between solid electrolyte and active material.

In some embodiments, the ratio of active material particles to dissolved electrolyte is determined based on a desired wt % of solid electrolyte in a cast electrode film. As discussed further below, an anode or cathode composition may have a wt % of solid electrolyte of between about 10%-33% or between about 10%-50%, and a wt % of active material between about 65%-88% or between about 20%-90%. The amount of active material added to the solution may be adjusted to achieve these respective wt % in the final film based on the assumption that all of the solid electrolyte in the final composition is from the electrolyte solution described in operation 210. In other embodiments, more active material is added than may be the respective wt % in the final film, and additional solid electrolyte is added after coating the active material as described in operation 270 below.

In some embodiments, the solution includes solvent, active material, and solid electrolyte, without any other added compounds. This may be desirable to improve the coating of active material with solid electrolyte. Adding other compounds to the solution may decrease the efficacy of coating active material particles, which is undesirable. Furthermore, in some embodiments the other compounds may undergo an undesirable reaction or phase change at higher temperatures, such as a temperature used to dry the coated active material or anneal the coated active material. Adding temperature unstable compounds before a thermal processing step may produce undesirable byproducts.

In operation 230 the solution is de-gassed. In some embodiments de-gassing is performed at below ambient pressure, less than about 700 torr, or less than about 600 torr. In some embodiments de-gassing is performed at a low temperature, such as 60° C., or at a temperature between about 25 and 78° C. De-gassing may be advantageous to fill pores of the active material with argyrodite. In some embodiments de-gassing may be performed under temperature and pressure where the solvent will undergo nucleate boiling, for example below about 80° C. at about atmospheric pressure for ethanol. This may be advantageous to avoid reducing the wetting of the surface of active material particles due to turbulence from the vaporizing solvent. Generally, better wetting leads to a better coating on the surface of active material particles, which increases contact area between the active material and the electrolyte.

In operation 240 solid electrolyte is precipitated out of the solution. Active material does not dissolve in the solution, but the precipitated electrolyte will precipitate into the pores of and onto the active material. Precipitation may be performed at a lower pressure than de-gassing, such as about 10 torr, or less than about 10 torr, and at a low temperature, such as between about 50° C. and 70° C. Operation 240 may be performed at the described temperature and pressure for similar reasons as operation 140 described above. In some embodiments operations 230 and 240 may be performed together, such that some electrolyte precursor may precipitate out of solution during operation 230. In some embodiments it is preferable to minimize precipitation during operation 230 to maximize the surface area of active material particles that may act as a nucleation site for precipitating electrolyte precursor during operation 240. The result of operation 240 is a composite material of active material coated with solid electrolyte. In some embodiments, the weight percent of solid electrolyte in the solid electrolyte/active material composite may be between about 5-30 wt %.

In operation 250 the coated active material is dried. Drying may be performed at a higher temperature than de-gassing or precipitation, such as at least 100° C. or about 140° C., as well as at reduced pressure, such as about 10 torr or less than about 10 torr. In some embodiments drying is performed for at least about 15 hours, or at least about 10 hours. Higher temperatures may be used for drying than for de-gassing or precipitation to further reduce any solvent contamination or carbonation. Remaining solvent or gas pockets may negatively affect the electrical conductivity or performance of the coated active material. Thus, drying may be advantageous to remove any undesirable contaminants in the coated active material. In some embodiments the remaining solvent is insufficient to negatively affect the coated active material if heated much higher than its boiling temperature, compared to de-gassing or precipitation in operations 230 and 240, respectively. Furthermore, during annealing the coated active material particles and/or electrolyte may sinter together, trapping solvent or gas pockets. Drying may reduce the amount of solvent or carbonation that is trapped during annealing, improving the electrical properties of the coated active material when incorporated into a cell, compared to annealing the coated active material after precipitating the solid electrolyte.

In operation 260 the dried, coated active material is annealed. During annealing, several competing processes may occur that affect the final properties of a solid electrolyte, such as argyrodite coated onto active material, primarily crystallization of the amorphous phase and growth of crystallites. Crystallization of the amorphous phase leads to improved conductivity and largely influences process-ability and grain boundaries. Growth of crystallites also affects conductivity but needs to be controlled to enable proper material transport and good sintering between crystallites without causing thermal degradation. Generally, annealing may improve the ionic conductivity of the solid electrolyte.

In some embodiments, annealing may be performed at a temperature between about 350-500° C. Annealing at temperatures higher than the temperature the coated active material is dried at may be advantageous, as ionic conductivity of solid electrolyte may improve as a function of annealing temperature, up to about 500° C. Thus, in some embodiments the coated active material does not include any other compounds, such as organic phase components, which may melt and lose functionality at a temperature used for annealing, such as temperatures greater than about 300° C. or greater than about 200° C.

Finally, in operation 270 a slurry is formed by mixing the coated active material with a solvent, and in some embodiments, other dry powders or binders. In some embodiments the solvent is THF. Other dry powders may include additives, which may be added to improve the manufacturability of a film made using the slurry described herein, the electrical properties of the film, the mechanical properties of the film, or the porosity of the film. For example, carbon black may be mixed with the coated active material particles. The combination of the coated active material, solvent, and additives may be accomplished by a roller mixer. Other mixing methods may be used as generally understood in the field.

Additives may be added to improve various properties. Example additives may be hydrogenated hydroxyl-terminated polyolefin (HLBH) or nitrile butadiene rubber (NBR). In some embodiments the additives are unavailable in a powder form.

Finally, operation 280 is an optional operation to cast the slurry formed in operation 270 to create a film. The film may be cast in a variety of ways. In some embodiments a film is cast by coating the slurry on aluminum foil such that the area mass loading is about 3 mAh/cm². In some embodiments the film is dried at an elevated temperature and reduced pressure. For example, the film may then be dried at a temperature of at least about 120° C. and at a reduced pressure of about 10 torr or no more than about 10 torr for at least about one hour.

In some embodiments, only operations 210-260 are performed. After the coated active material is annealed, it may be stored. It may then be used in a separate operation to form a slurry. In some embodiments operation 250 is not performed, and the coated active material is annealed after precipitating the coated active material. In some embodiments, operation 270 instead comprises mixing the coated active material with dry additives, without forming a slurry. The dry mixture may then be stored or transferred for later use.

### Hybrid Materials

In some embodiments, the materials described herein may be incorporated into hybrid materials that include a particulate inorganic phase (including the coated active materials) and an organic polymer phase. Polymers or precursors of the organic phase may be added at operation 170 in FIG. 1 or operation 270 in FIG. 2, for example.

The organic phase may include one or more polymers and is chemically compatible with the inorganic ion conductive particles. In some embodiments, the organic phase has substantially no ionic conductivity, and is referred to as “non-ionically conductive.” Non-ionically conductive polymers are described herein have ionic conductivities of less than 0.0001 S/cm.

In some embodiments, the organic phase includes a polymer binder, a relatively high molecular weight polymer. A polymer binder has a molecular weight of at least 30 kg/mol, and may be at least 50 kg/mol, or 100 kg/mol. In some embodiments, the polymer binder has a non-polar backbone. Examples of non-polar polymer binders include polymers or copolymers including styrene, butadiene, isoprene, ethylene, and butylene. Styrenic block copolymers including polystyrene blocks and rubber blocks may be used, with examples of rubber blocks including polybutadiene (PBD) and polyisoprene (PI). The rubber blocks may or may be hydrogenated. Specific examples of polymer binders are styrene ethylene butylene styrene (SEBS), styrene-butadiene-styrene (SBS), styrene-isoprene-styrene (SIS), styrene-butadiene rubber (SBR), polystyrene (PSt), PBD, polyethylene (PE), and PI. Non-polar polymers do not coat the inorganic particles. Coating the particles can lead to reduced conductivity.

Smaller molecular weight polymers may be used to improve the processability of larger molecular weight polymers such as SEBS, reducing processing temperatures and pressures, for example. These can have molecular weights of 50 g/mol to 30 kg/mol, for example. Examples include polydimethylsiloxane (PDMS), polybutadiene (PBD), polystyrene, a cyclic olefin polymer (COP). A COP is a polymer molecule or chain that includes multiple cyclic olefin monomers (e.g., norborene). COPs include cyclic olefin copolymers (COCs), which are produced by copolymerization of a cyclic olefin monomer with a monomer such as ethylene. Polyolefins include one, two, or more different olefin (CnH2n) monomers and only carbon and hydrogen as well as fully or partially saturated derivatives thereof.

The main chain or backbone of the polymeric components of the organic phase do not interact with the inorganic phase. Examples of backbones include saturated or unsaturated polyalkyls, polyaromatics, and polysiloxanes. Examples of backbones that may interact too strongly with the inorganic phase include those with strong electron donating groups such as polyalcohols, polyacids, polyesters, polyethers, polyamines, and polyamides. It is understood that molecules that have other moieties that decrease the binding strength of oxygen or other nucleophile groups may be used. For example, the perfluorinated character of a perfluorinated polyether (PFPE) backbone delocalizes the electron density of the ether oxygens and allows them to be used in certain embodiments.

The organic phase polymers have polymer backbones that are non-volatile. In some embodiments, the polymer backbones do not interact too strongly with the inorganic phase, and may be characterized as non-polar or low-polar. Highly polar polymers such as polyvinylacetate and polyethylene oxide (PEO) may not be effective polymer backbones as they may interact too strongly with the inorganic phase. Polymers that require highly polar solvents (e.g., polyvinylidene fluoride (PVDF)) may not be appropriate, as such solvents are incompatible with inorganic particles such as sulfide glasses.

For certain polymer classes such as polyvinyl, polyacrylamide, polyacrylic, and polymaleimide polymers, the polarity is highly dependent on the identity of their constituent monomers. While some such polymers (e.g., polyvinylacetate) may be too polar, it is possible that less polar polymers in these classes (e.g., poly(dodecyl-n-vinyl ether) may be used as backbones. Further, in some embodiments, these polymer classes may be included in a copolymer backbone along with a non-polar polymer (e.g., a polyolefin).

The polymers may be functionalized with one or more end groups. In the description herein, polarity of a functionalized polymer component is determined by its backbone. For example, a non-polar polymer may have a non-polar linear PDMS backbone that is functionalized with polar end groups. Certain functional groups enable the formation of polymerization in an in-situ polymerization reaction described below. Examples of end groups include cyano, thiol, amide, amino, sulfonic acid, epoxy, carboxyl, or hydroxyl groups. The end groups may also have surface interactions with the particles of the inorganic phase.

In some embodiments, the glass transition temperature of the polymer backbone is relatively low, e.g., less than about −50° C., less than about −70 C, less than about −90° C., or lower. In some embodiments, the polymer is an elastomer. Specific examples of polymer backbones include PDMS (Tg of −125° C.) and polybutadiene (PBD) (Tg of −90° C. to −111° C.). Further examples include styrene butadiene rubbers (SBRs) (Tg of −55° C.), ethylene propylene rubbers (EPRs) (Tg of −60° C.), and isobutylene-isoprene rubbers (IIRs) (Tg of −69° C.). The glass transition temperatures as provided herein are examples and may vary depending on the particular composition and/or isomeric form of the polymer. For example, the glass transition temperature of PBD can depend on the degree of cis, trans, or vinyl polymerization. Crystalline polymer backbones may also be characterized in terms of melting temperature Tm. Crystalline backbones may have a melting temperature less than about room temperature in some embodiments. In some embodiments, if the hybrid is heat processed (as described below), the melting temperature may be higher, e.g., less than 150° C., less than 100° C., or less than 50° C. For example, PDMS (Tm of −40° C.) may be preferred in some embodiments over polyethylene (PE; Tm of 120° C. to 180° C.) as the former is liquid at lower temperatures. Melting temperatures as provided herein are examples and may vary depending on the size, particular composition and/or isomeric form of the polymer. Melting temperatures of PBD, for example, vary significantly on the degree of cis, trans, or vinyl polymerization.

The polymers of the polymer matrix may be homopolymers or copolymers. If copolymers are used, both or all of the constituent polymers of the copolymers have the characteristics described above (non-volatile, non-polar or low-polar, etc.). Copolymers may be block copolymers, random copolymers, or graft copolymers.

In some embodiments, hydrophobic block copolymers having both plastic and elastic copolymer segments are used. Examples include styrenic block coploymers such as SEBS, SBS, SIS, styrene-isoprene/butadiene-styrene (SIBS), styrene-ethylene/propylene (SEP), styrene-ethylene/propylene-styrene (SEPS), and isoprene rubber (IR).

As noted above, in some embodiments, the organic phase is substantially non-ionically conductive, with examples of non-ionically conductive polymers including PDMS, PBD, and the other polymers described above. Unlike ionically conductive polymers such as polyethylene oxide (PEO), polypropylene oxide (PPO), polyacrylonitrile (PAN), poly(methyl methacrylate) (PMMA), which are ionically conductive because they dissolve or dissociate salts such as LiI, non-ionically conductive polymers are not ionically conductive even in the presence of a salt. This is because without dissolving a salt, there are no mobile ions to conduct. In some embodiments, one of these or another ionically conductive polymer may be used. PFPE's, referred to above, and described in Compliant glass-polymer hybrid single ion-conducting electrolytes for lithium ion batteries, PNAS, 52-57, vol. 113, no. 1 (2016), incorporated by reference herein, are ionically conductive, being single ion-conductors for lithium and may be used in some embodiments.

In some embodiments, the organic phase may included cross-linking. In some embodiments, the organic phase is a cross-linked polymer network. Cross-linked polymer networks can be cross-linked in-situ, i.e., after the inorganic particles are mixed with polymer or polymer precursors to form a hybrid. In-situ polymerization, including in-situ cross-linking, of polymers is described in U.S. Pat. No. 10,079,404, incorporated by reference herein.

The organic matrix phase may contain functional groups that enable the formation of polymerization in an in-situ polymerization reaction. Examples of end groups include cyano, thiol, amide, amino, sulfonic acid, epoxy, carboxyl, or hydroxyl groups. These may be present in the organic phase as unreacted reactants, byproducts, or as linking groups. In some embodiments, wherein the polymer network includes one or more linking groups selected from:

1) —CH2CH(H/CH3)(R) where R=—C(O)—O—, —C(O)—NR—, —C6H4-, or

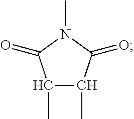

2) —NH—C(O)—NR—, where R is H, alkyl or aryl;

### 3) —NH—C(O)—O—; and

### 4) —NH—C(O)—S—.

In some embodiments, the composition includes one or more unreacted reactants or byproducts of a polymerization reaction. In some embodiments, the unreacted reactant includes isocyanate functional groups. The isocyanate functional groups may be blocked. In some embodiments, the unreacted reactant includes one or more of an amine functional group, an alcohol functional group, a thiol functional group, and a blocked isocyanate. In some embodiments, the unreacted reactant includes one or more functional cross-linkers. In some embodiments, the unreacted reactant includes a radical initiator. In some embodiments, the unreacted reactant includes functional groups selected from one or more of: an acrylic functional group, a methacrylic functional group, an acrylamide functional group, a methacrylamide functional group, a styrenic functional group, an alkenyl functional group, an alkynyl functional group, a vinyl functional group, allyl functional group, and a maleimide functional group. In some embodiments, the unreacted reactant includes functional groups selected from one or more of: epoxy resins, oxiranes, glycidyl groups, and alkene oxides.

In some embodiments, the organic phase includes a polyurethane network, poly(urea-urethane) network, or polythiourethane network. Such a network may be cross-linked. Polyurethanes (including poly(urea-urethanes) and polythiourethanes) are versatile, offering the ability to manipulate their mechanical properties through composition and processing. The materials exhibit an outstanding ability to withstand more loads than rubber due to their hardness and at the same time, they are more flexible than plastics, which accounts for their strength and ability to withstand impact.

The physical properties of polyurethanes described herein come from their segmented nature and phase separation behavior. In particular, in some embodiments, the polymer matrix includes thermodynamically incompatible soft (SS) and hard segments (HS) (also referred to as soft domains and hard domains, respectively) that respectively confer elastomeric and physical-crosslinking behaviors. This leads to microphase separation and formation of domains on 5 nm-100 nm scale.

The hard domains in the organic phase are composed of short urethane blocks that are connected via hydrogen bonding and are responsible for formation of physical cross-links. The soft segments are typically lower polarity polymers, with the hard phase being small molecules, isocyanates, polar chain extenders and cross-linkers. According to various embodiments, the amount of hard phase in the organic phase is between 5% and 50%, and may be between 15% and 30% by weight, or between 20% and 30% by weight according to various embodiments. The hard phase content may be calculated by the following:

$$Hard phase content = \frac{\begin{matrix}mass of chain extender + mass of cross - \\ linker + mass of isocyanate\end{matrix}}{total mass} \times 100 \%$$

In some embodiments, the organic phase has a hard phase content of between about 5% and 50% and includes one or more of a cross-linked polyurethane network, a cross-linked poly(urea-urethane) network, and a cross-linked polythiourethane network. In some embodiments, the hard phase includes a chain extender selected from: ethylene glycol, propylene glycol, triethylene glycol, tetraethylene glycol, propylene glycol, dipropylene glycol, 1,3-propanediol, 1,3-butanediol, 1,4-butanediol, neopentyl glycol, 1,6-hexanediol, 1,12-dodecanediol, 1,4-cyclohexanedimethanol, 2-butyl-2-ethyl-1,3-propanediol, 2-ethyl-1,3-hexanediol (EHD), 1,4-bis(2-hydroxyethoxy)benzene, ethanolamine, diethanolamine, methyl di ethanol amine, 1,12-diaminododecane, phenyldiethanolamine, 4,4′-ethylene dianiline, dimethylthiotoluenediamine, diethyl toluene diamine, 4,4′-methylene-bis-2,6-diethyl aniline, and m-xylene diamine.

In some embodiments, the hard phase includes a cross-linker selected from: glycerol, trimethylolpropane, 1,2,6-hexanetriol, diethylenetriamine, triethanolamine, tetraerythritol, pentaerythriol, N,N-bis(2-hydroxypropyl)aniline, triisopropanolamine (TIPA), and N,N,N′N″-tetrakis(2-hydroxypropyl)ethylenediamine.

The soft phase may be derived from any appropriate polyol, and may include a non-polar backbone. Examples of non-polar and low-polar backbones include polysiloxanes, polyolefins, polystyrene, cyclic olefin polymers (COPs), polyethers such as PTHF, polyesters including esters of fatty acid dimers and polycaprolactones, and polyamides such as polycaprolactam. Non-polar examples include PBD; low polar examples include PCL and PTHF. In some embodiments, the soft phase is derived from a film having polarity of PTHF or less. The hard phase includes the isocyanate groups used to form the polyurethanes, as well as any cross-linkers and chain extenders, as described above.

### Devices

The coated active materials may be incorporated into any electrochemical cell device. In particular, they described herein may be incorporated into any device that uses an ionic conductor, including but not limited to batteries and fuel cells. In a lithium battery, for example, the coated active particles may be used as in an electrode. In some embodiments, the coated active material particles are provided in a hybrid material. The electrode compositions may optionally contain a conductive additive. Example cathode and anode compositions are given below.

For cathode compositions, the table below gives example compositions.

| Constituent | Active material | Solid Electrolyte | Electronic | Organic phase |
|---|---|---|---|---|
| | | | conductivity | |
| | | | additive | |
| Examples | Transition Metal | Li₃PS₄ | Carbon-based | Hydrophobic block |
| | Oxide | Li₆PS₅Cl | Activated | copolymers having soft |
| | | | carbons | and hard blocks |
| | Transition Metal | Li_{5.6}PS_{4.6}Cl_{1.4} | CNTs | SEBS |
| | Oxide with layer | | Graphene | |
| | structure | | Graphite | |
| | NMC | | Carbon fibers | |
| | | | Carbon black | |
| | | | (e.g., Super C) | |
| Wt % range | 65%-88% | 10%-33% | 1%-5% | 1%-5% |

According to various embodiments, the cathode active material is a transition metal oxide, with lithium nickel cobalt manganese oxide (LiMnCoMnO₂, or NMC) an example. Various forms of NMC may be used, including LiNi_{0.6}Mn_{0.2}Co_{0.2}O₂ (NMC-622), LiNi_{0.4}Mn_{0.3}Co_{0.3}O₂ (NMC-433). etc. The lower end of the wt % range is set by energy density; compositions having less than 65 wt % active material have low energy density and may not be useful.

Any appropriate solid electrolyte that can dissolve in a solvent, or be produced from a precursor that can dissolve in a solvent, may be used. Li_{5.6}PS_{4.6}Cl_{1.4} is an example of an argyrodite that has high ionic conductivity and good mechanical properties. Compositions having less than 10 wt % argyrodite have low Li+ conductivity.

An electronic conductivity additive is useful for active materials that, like NMC, have low electronic conductivity. Carbon black is an example of one such additive, but other carbon-based additives including other carbon blacks, activated carbons, carbon fibers, graphites, graphenes, and carbon nanotubes (CNTs) may be used. Below 1 wt % may not be enough to improve electronic conductivity while greater than 5% leads to decrease in energy density and disturbing active material-argyrodite contacts. Additives may be added as part of a dry mixture with the coated active material, such as described in operation 160 or operation 270, above.

Any appropriate organic phase may be used. In particular embodiments, hydrophobic block copolymers having both plastic and elastic copolymer segments are used. Examples include styrenic block coploymers such as styrene-ethylene/butylene-styrene (SEBS), styrene-butadiene-styrene (SBS), styrene-isoprene-styrene (SIS), styrene-isoprene/butadiene-styrene (SIBS), styrene-ethylene/propylene (SEP), Styrene-Ethylene/Propylene-Styrene (SEPS), and isoprene rubber (IR). Below 1 wt % may not be enough to achieve desired mechanical properties while greater than 5% leads to decrease in energy density and disturbing active material-argyrodite-carbon contacts.

For anode compositions, the table below gives examples of compositions.

| | | | | | |
|---|---|---|---|---|---|
| Constituent | Primary active | Secondary active | Solid Electrolyte | Electronic | Organic phase |
| | material | material | | conductivity | |
| | | | | additive | |
| Examples | Si- | Graphite | Li₆PS₅Cl | Carbon-based | Hydrophobic block |
| | containing | | Li_{5.6}PS_{4.6}Cl_{1.4} | Activated | copolymers having |
| | Elemental Si | | | carbons | soft and hard blocks |
| | Si alloys, | | | CNTs | SEBS |
| | e.g., Si | | | Graphene | |
| | alloyed with | | | Carbon fibers | |
| | one or more | | | Carbon black | |
| | of Al, Zn, | | | (e.g., Super C) | |
| | Fe, Mn, Cr, | | | | |
| | Co, Ni, Cu, | | | | |
| | Ti, Mg, Sn, | | | | |
| | Ge | | | | |
| Wt % | Si is 15%-50% | 5%-40% | 10%-50% | 0%-5% | 1%-5% |
| range | | | | | |

Graphite is used as a secondary active material to improve initial coulombic efficiency (ICE) of the Si anodes. Si suffers from low ICE (e.g., less than 80% in some cases) which is lower than ICE of NMC and other cathodes causing irreversible capacity loss on the first cycle. Graphite has high ICE (e.g., greater than 90%) enabling full capacity utilization. Hybrid anodes where both Si and graphite are utilized as active materials deliver higher ICE with increasing graphite content meaning that ICE of the anode can match ICE of the cathode by adjusting Si/graphite ratio thus preventing irreversible capacity loss on the first cycle. ICE can vary with processing, allowing for a relatively wide range of graphite content depending on the particular anode and its processing. In addition, graphite improves electronic conductivity and may help densification of the anode.

Any appropriate solid electrolyte or electrolyte precursor may be used. Li_{5.6}PS_{4.6}Cl_{1.4} is an example of an argyrodite that has high ionic conductivity and good mechanical properties. Compositions having less than 10 wt % argyrodite have low Li+ conductivity.

A high-surface-area electronic conductivity additive (e.g., carbon black) may be used some embodiments. Si has low electronic conductivity and such additives can be helpful in addition to graphite (which is a great electronic conductor but has low surface area). However, electronic conductivity of Si alloys can be reasonably high making usage of the additives unnecessary in some embodiments. Other high-surface-area carbons (carbon blacks, activated carbons, graphenes, carbon nanotubes) can also be used instead of Super C. Additives may be added as part of a dry mixture with the coated active material, such as described in operation 160 or operation 270, above.

Any appropriate organic phase may be used. In particular embodiments, hydrophobic block copolymers having both plastic and elastic copolymer segments are used. Examples include styrenic block coploymers such as styrene-ethylene/butylene-styrene (SEBS), styrene-butadiene-styrene (SBS), styrene-isoprene-styrene (SIS), styrene-isoprene/butadiene-styrene (SIBS), styrene-ethylene/propylene (SEP), Styrene-Ethylene/Propylene-Styrene (SEPS), and isoprene rubber (IR). Below 1 wt % may not be enough to achieve desired mechanical properties while greater than 5% leads to decrease in energy density and disturbing active material-argyrodite-carbon contacts.

### Example Embodiments

The following examples are provided to further illustrate aspects of various embodiments. This example is provided to exemplify and more clearly illustrate aspects and is not intended to be limiting.

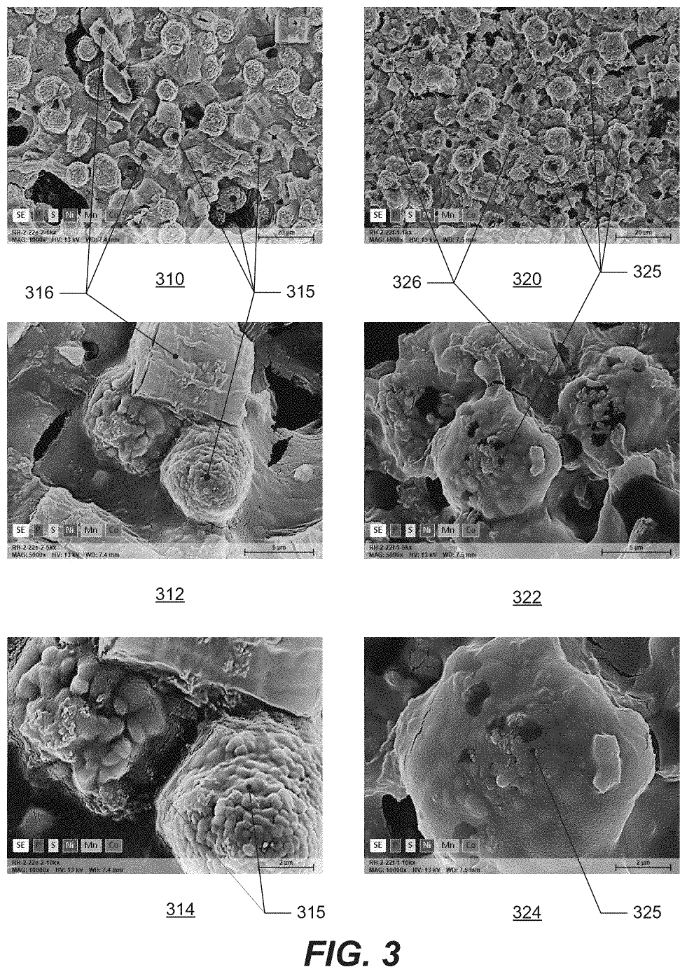

FIG. 3 provides scanning electron microscopy images as elemental maps for two different films. Images 310-314 are from a film made using a process that does not include coated active material as described herein. Images 320-324 are from a film made using coated active material.

Specifically, images 310-314 are from a film that was made as follows:
1. Mix Li₂S, P₂S₅, ALD-NMC622, and Super C65 dry powders via ball milling,
2. Add THF solvent, HLBH 2000, and NBR to the dry powder mixture to form a slurry,
3. Mix the slurry using roller mixer,
4. Coat the slurry on Al foil and cast the film.

Images 320-324 are from a film made using coated active material, following a process similar to the process described in FIG. 1:
1. Dissolve Li₂S in ethanol to make a 3.0 wt % solution,
2. Add ALD-coated NMC622 to the solution and stir,
3. De-gas the solution by pulling vacuum at a low temperature,
4. Dry the Li₂S/ALD-NMC composite powder at a high temperature,
5. Mix the composite powder with P₂S₅ and Super C65,
6. Add THF solvent, HLBH 2000, and NBR to form a slurry,
7. Coat the slurry on Al foil and cast the film.

The resulting films of each process have notable differences. NMC particles 325, which are blue/purple and round in shape, have greater amounts of solid electrolyte (red/orange) on the surface for the film made with coated active material than NMC particles 315 from the film made without coated active material. LPS particles 316 from the film without coated active material shows numerous rectangular or angular particles, while LPS particles 326 in image 320 are less angular, resulting in better contact between NMC and LPS particles. Furthermore, NMC particles 315 are noticeably rougher than NMC particles 325 as seen in images 314 and 324, partially due to the coating of LPS acting as an electronic insulator and masking the NMC particle's morphology.

Quantitatively, each film was examined using Energy Dispersive X-Ray Spectroscopy (EDS) to determine the relative mass percent of Sulfur to Nickel on randomly sampled particles and across the film. Higher amounts of Sulfur indicate a better coating of solid electrolyte on the NMC particles. For the film made without the coated active material, the average mass % of Sulfur on NMC particles varied between about 17% and 31%, with an average of about 27%. For the film made with coated active material as described herein, the mass % of Sulfur on NMC particles varied between about 40% and 53%, with an average of about 45%, indicating that the coated active material as described herein increases the coating of NMC particles.

Measurements were also taken across the film as a whole. Table 1, below, details the average mass % for both films, as well as the standard deviation of measured mass %. While the mean mass % of sulfur for both films is relatively close (76.47% and 78.97%), the standard deviations are much larger (18.39 and 5.26). These numbers may result from a majority of the points that were sampled containing mostly electrolyte, skewing the mass % Sulfur numbers higher, but when a sample point contained NMC, the film made without the coated active material measured a considerably lower mass % of Sulfur than the film made with coated active material, causing the larger standard deviation.

| | Without Coated Active | | With Coated Active | |
|---|---|---|---|---|
| | Material | | Material | |
| | S (mass %) | Ni (Mass %) | S (mass %) | Ni (mass %) |
| Mean | 76.47 | 23.54 | 78.98 | 21.03 |
| Standard | 18.39 | 18.39 | 5.26 | 5.26 |
| Deviation | | | | |

Table 1: Details of Sulfur and Nickel Mass percent at 48 random points on a film made without a pre-processed solution and a film made using a pre-processed solution as described herein.

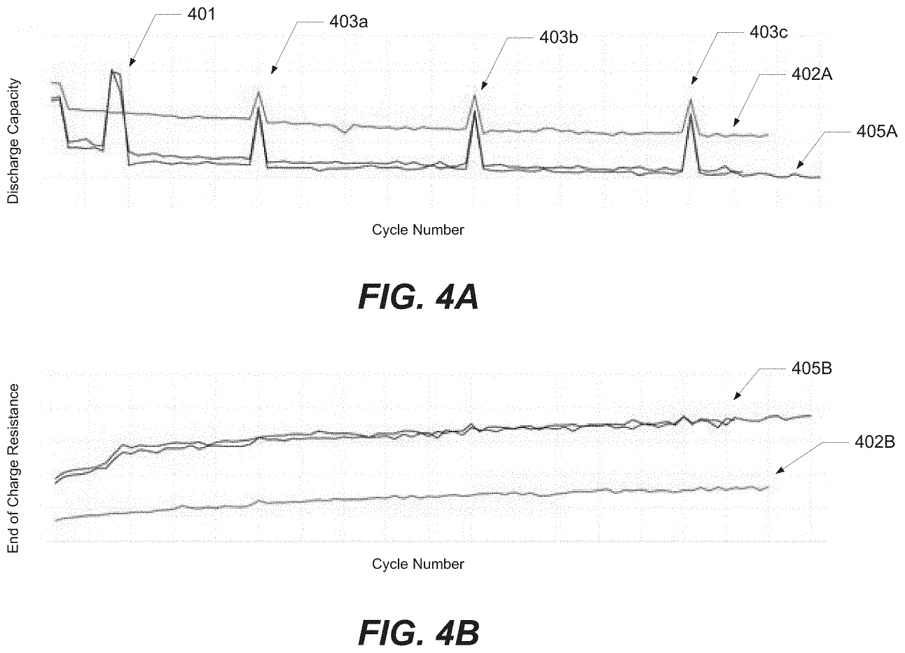

In addition to analyzing the films at a molecular level, films made with and without coated active material were tested for electrical properties. FIG. 4A presents a graph of discharge capacity vs cycle number, where test cells were initially cycled twice at C/20 rates with an electrode loading of about 3.0 mAh/cm², and then repeatedly cycled at C/10 rates. Generally, better discharge capacity is desirable. Spikes 403a-c represent a cycle at a C/20 rate. Spike 401 is believed to represent a protocol error, causing erroneous data that is not reflective of the test cell's electrical properties. Line 402A represents a test cell made using coated active material as described herein, and line 405A represents a test cell made without coated active material. As can be seen, line 402A presents a consistently better discharge capacity across loading cycles. Test cells using the coated active material retained about 77% of their C/20 capacity after cycling at C/10 discharge rates, compared to test cells prepared without the coated active material, as described above, which retained about 50% of their C/20 capacity after cycling at C/10 discharge rates.

FIG. 4B presents a graph of End of Charge Resistance vs cycle number. Generally, lower end of charge resistance is desirable. Line 402B represents a test cell made using coated active material as described herein, and line 405B represents a test cell made without coated active material. Similar to FIG. 4A, a test cell made using coated active material as described herein performed better than a test cell made without the coated active material, having a lower end of charge resistance across 80+ cycles.

### CONCLUSION

The foregoing describes the instant invention and its certain embodiments. Numerous modifications and variations in the practice of this invention are expected to occur to those skilled in the art. For example, while the above specification describes electrolytes and electrodes for alkali ion or alkali metal batteries, the compositions described may be used in other contexts. For example, in capacitors, or solid oxide fuel cells. Further, the batteries and battery components described herein are not limited to particular cell designs. Such modifications and variations are encompassed within the following claims.

1. A method comprising:
dissolving an electrolyte precursor in a solvent to form a solution;
adding active material to the solution;
precipitating the electrolyte precursor out of the solution to form a composite powder; and
mixing the composite powder with a slurry solvent.

2. The method of claim 1, further comprising:
mixing the composite powder with an electrolyte reactant, and
reacting the electrolyte precursor of the composite powder with the electrolyte reactant in the presence of the solvent to form an electrolyte coating on the active material.

3. The method of claim 1, further comprising mixing the composite powder with one or more additives.

4. The method of claim 3, wherein the one or more additives are one or more of carbon, carbon fiber, graphene, or organic phase additives.

5. The method of claim 1, wherein the weight percent of electrolyte precursor in the solution is at most about 3.0 wt %.

6. The method of claim 1, further comprising drying the composite powder prior to mixing the composite powder with a solvent.

7-9. (canceled)

10. A composition, comprising:
a dry mixture of:
particles of an active material for a lithium ion battery electrode, the particles at least partially coated with a layer of Li₂S; and
P₂S₅.

11. The composition of claim 10, wherein the active material is NMC, and an average mass percent of sulfur on the active material, as calculated by the equation
$$\frac{mass of Sulfur}{mass of Sulfur + mass of Nickel} \times 100 \%$$
is at least 40%.

12. The composition of claim 10, wherein the active material is NMC and the particles are homogenously coated as characterized by a standard distribution of mass percent of sulfur of no more than 10% across the particles, wherein mass percent of sulfur on the active material is calculated by the equation
$$\frac{mass of Sulfur}{mass of Sulfur + mass of Nickel} \times 100 \% .$$

13-16. (canceled)

17. The composition of claim 10, wherein the composition does not include additives.

18. The composition of claim 10, further comprising an electronic conductivity additive.

19. The composition of claim 10, further comprising an organic phase additive.

20. The composition of claim 10, wherein a molar ratio between Li₂S and P₂S₅ is between about 3:1 and about 1:1.

21. The composition of claim 10, wherein a battery cell using an electrode made from the composition of claim 1 has a C/10 capacity that is at least 77% of its C/20 capacity.

22. A composition, comprising:
a slurry precursor solution comprising:
particles of an active material for a lithium ion battery electrode, the particles at least partially coated with a layer of Li₂S;
P₂S₅; and
slurry solvent.

23. The composition of claim 22, wherein the active material is NMC, and an average mass percent of sulfur on the active material, as calculated by the equation
$$\frac{mass of Sulfur}{mass of Sulfur + mass of Nickel} \times 100 \%$$
is at least 40%.

24. The composition of claim 22, wherein the active material is NMC and the particles are homogenously coated as characterized by a standard distribution of mass percent of sulfur of no more than 10% across the particles, wherein mass percent of sulfur on the active material is calculated by the equation
$$\frac{mass of Sulfur}{mass of Sulfur + mass of Nickel} \times 100 \% .$$

25-29. (canceled)

30. The composition of claim 22, further comprising an electronic conductivity additive.

31. (canceled)

32. The composition of claim 22, wherein a molar ratio between Li₂S and P₂S₅ is between about 3:1 and about 1:1.

33. The composition of claim 22, wherein a battery cell using an electrode made from the composition of claim 1 has a C/10 capacity that is at least 77% of its C/20 capacity.

34-42. (canceled)
